(19) United States
(12) Patent Application Publication
(10) Pub. No.: US 2005/0018450 A1
(43) Pub. Date: Jan. 27, 2005

(54) Fiber optic light kits for footwear

(76) Inventor: Tseng-Lu Chien, Taipei Hseng (TW)

Correspondence Address: BACON & THOMAS, PLLC, 625 SLATERS LANE, FOURTH FLOOR, ALEXANDRIA, VA, 22314, US

(21) Appl. No.: 10/883,747

(22) Filed: Jul. 6, 2004

Related U.S. Application Data
(63) Continuation-in-part of application No. 10/170,584, filed on Jun. 14, 2002, now abandoned.
(63) Continuation-in-part of application No. 10/285,451, filed on Nov. 1, 2002.
(63) Continuation-in-part of application No. 10/286,820, filed on Nov. 4, 2002.

(51) Int. Cl. G02B 6/04

(52) U.S. Cl. 362/565

(57) ABSTRACT

The current invention applied the fiber optics on a basic substrate with proper attachment means to attach the fiber optics to the basic substrate with desired density to become a display unit which connected with LED(s) light means by adaptor-means to make precisely alignment the light beams into the bundle of fiber optics for brighter illumination. The LED(s) connected with circuit by conductive-means to delivery the electric signals which created from the integrated circuit triggered by push on and off switch by weight. The power source is consist of polarity of the batteries which in desired electric connection combination selected from in-series, and in-parallels to drive the different color LED(s) by different voltage and amperage from the batteries. Furthermore, the battery compartment maybe designed for waterproof with knobs to make batteries replacement for make the said light kits with permanent life than any conventional light kits.

The current invention applied the fiber optics on a basic substrate with proper attachment means to attach the fiber optics to the basic substrate with desired density which connected with LED(s) light means by adaptor-means for alignment the light beams into the bundle of fiber optics for brighter illumination. The LED(s) connected with circuit by conductive-means to delivery the electric signals which created from the integrated circuit triggered by push on and off switch by weight. The power source is consist of polarity of the batteries which in desired electric connection combination selected from in-series, and in-parallels to drive the different color LED(s) by different voltage and amperage from the batteries.

### BACKGROUND OF THE INVENTION

This application is a continuation-in-part of U.S. patent application Ser. No. 10/170,584, filed Jun. 14, 2002 and Ser. No. 10/285,451, filed Nov. 4, 2002 and Ser. No. 10/286,820, filed Nov. 4, 2002.

The current invention related to apply the fiber optics elements for footwear. The US prior art U.S. Pat. No. 5,813,148 Guerra disclosure a fiber optics for logo, trademark, characters, cartoon and wording for shoe upper, outsole, shoe tong but have to having the window, cut-out, or transparent stencil. This will different with current invention for the fiber optics directly passing though the footwear material process.

The current invention also made a big difference for the LED location because the fiber optics still have big problem for its clearance so the longer length from the LED tip to the tip of Fiber Optics will cause the light brightness dropped dramatically. The current invention apply the LED tip to the fiber optics tip with the shortest distance and the LEDs never within the power source box which located inside the shoe bottom. These two features made a big improvement from the Guerra's '148 prior arts.

The other prior arts of Roger's U.S. Pat. Nos. 4,848,009, 5,343,190 and Wei's U.S. Pat. No. 6,525,487 and Weng's U.S. Pat. No. 5,663,614 and Anteby's U.S. Pat. Nos. 6,280,045, 6,354,712 and Wut's U.S. Pat. Nos. 6,104,140, 5,909,088, 5,866,987 and Other US prior arts U.S. Pat. Nos. 5,033,212, 5,329,432, 5,394,312, 5,371,662, 5,438,488, 5,465,032, 5,479,900 all related to use a vibration switch and IC circuit will start to work basing on the contact point timing and make the IC drive LEDs for certain on duration by different limitation. All these prior art is not same as current invention for the IC with motion light with Fiber Optics for light performance with press sensitive (Preferred for push on and off switch) to prevent from the delivery power consumption to waste limited batteries power.

The current invention relates to apply the Fiber Optics with preferable designs and shape with desired dimension with proper light means may selected from Light Emit Diode (hereafter as LED) in different treatment may selected from group combination of the dice, chip, sealed unit, LOD to have pre-designed light function though all the Bundle of fiber optics.

The current invention also applied the push-on-off switch to drive the said light means to perform the desired functions may including from group combination for steady, all flashing, chasing, fade in and out, sequential, pair flashing, random flashing with desired On and off timing period for each piece of LED while the system been triggered.

The Current invention applied the fiber Optics incorporating with the textile, cloth, leather, paper, woods, plastic, metal sheets and make the Fiber Optics can be into a shape with desired colors, fold, flexible, curvature, dimensions to create a nice and elegant appearance with dynamite light effects to make fatal attraction to all consumer for footwear including the beach sandal, Athletic shoe, Sport Sandal, boots, woman shoe, fashion shoe, vocalize shoe, or any footwear for human to wear on foot.

The current invention applied the fiber optics, light means together to get the maximum light brightness by a quickly adaptor device to allow all the light beams to each of fiber optics without any waste.

### BRIEF DESCRIPTION OF THE DRAWINGS

FIG. 1: Disclosure the 1^{st} embodiment for a beach sandal with preferred adaptor device, fiber optics, conductive means, push on/off switch, power source and the Integrated circuit.

FIG. 2: Disclosure the 2nd embodiment disclosure the details of the fiber optics arrangement with basic substrate which is a kind of textile, cloth, metal, plastic, woods to allow the fiber optics can be arranged on the surface and fix on position and its adaptor device and light means arrangement.

FIG. 3: Disclosure the 3^{rd} embodiment which have a basic substrate with super thin thickness and all the fiber optics are passing though all pre-designed holes with alternative simple adaptor-means by black color tape because there have small quantity of fiber optics so can apply to the indoor slipper shoe upper surface. The basic substrate is part of the footwear for this embodiment.

FIG. 4: Disclosure the 4ₜₕ embodiment which have a basis substrate with super thin thickness and all the fiber optics fix on the said substrate to become a display unit which connected with battery compartment which contained the plurality of LED(s), circuit board, IC, batteries, conductive means, removable battery cover to allow people to replace batteries.

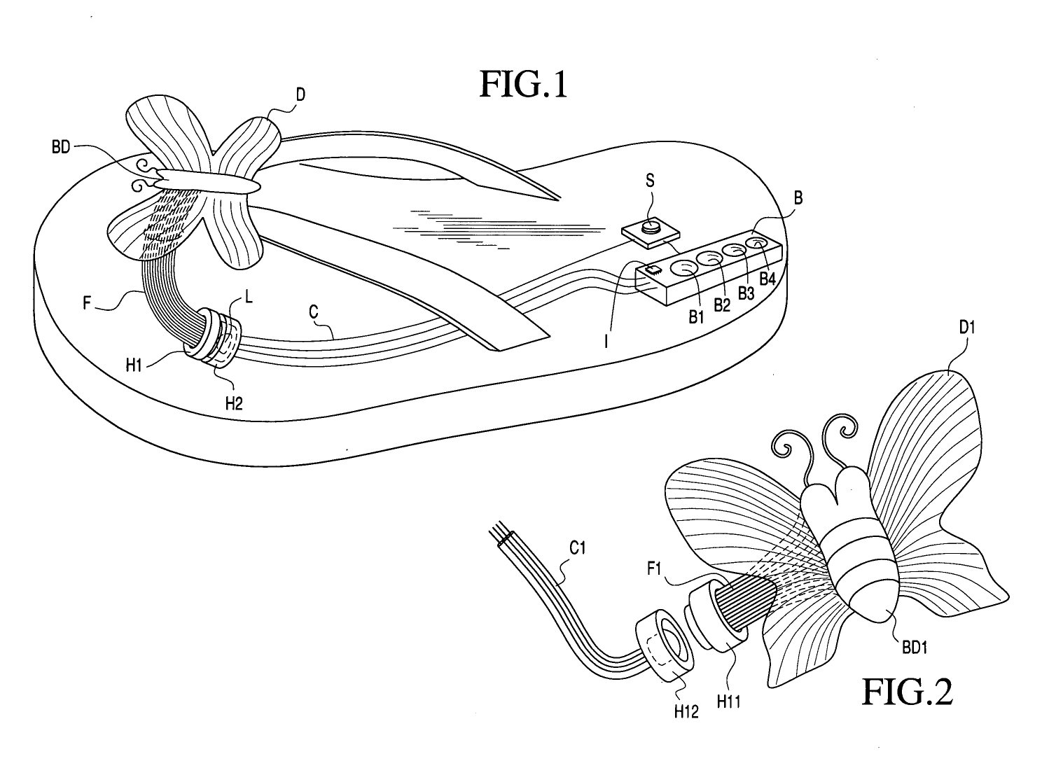

### DETAILED DESCRIPTION OF THE PREFERRED EMBODIMENTS

The current invention applied the fiber optics with a basic substrate may selected from group combination from the paper, wood, plastic, metal, textile, cloth with proper attachment means to arrange the said fiber optics fixed and hold on the surface and position of the basic substrate without deviation. The colors means can apply to the basic substrate to allow the surface have desired color, brightness, shape, dimension. The basic substrate may offer the features of the flexible, bendable, durable quality so can meet the designed features.

From FIG. (1) disclosure a fiber optics butterfly which all fiber optics incorporated with the bonding means may selected from the group combination of the glue, solvent, double side tape, hot sealing, bonding material, super glue or the equivalent material so can hold each fiber optics on the surface of basic substrate without any off separated, deviation concern. The basic substrate offer a certain features such as cutting, bending, folding, elastic, waterproof, environment so can allow worker to make designed shape and curvature to make butterfly look like alive. The (D) is a shape of butterfly and one side is fixed all fiber optics and the other side can adding the painting means to apply to get the desired color, brightness, shape. The basic substrate can install the decorative means such as the body (BD). The body (BD) of the butterfly is a plastic unit which can get good optics properties may including reflective, deflective, transmission rate, random reflective to increase the light effects.

The each fiber optics come to the bottom and form a bundle (F) which have a male adaptor means (H1) to hold each of fiber optics together tightly and hold on position to connected the female adaptor means (H2) which is allow the desired light means on the fixed position so all the light beams out of the light source (L) will come into the fiber optics bundle (F). The proper light means(L) been selected basing on the bundle (F) size and dimension so allow each of fiber optics of the said butterfly (D) can be very good brightness. The light means can be a single piece of LED or multiple pieces of LED(s) to cause the butterfly been very bright and rich of colors changing as desired light effects.

The light means (L) are well install inside of the adaptor means (H2) with desired conductive means to allow the butterfly (D) can install on any location. The conductive means (C) deliver the electric signals to the light means (L) to turn on the light while the switch means(S) been pushed by the human foot or pressed by other objects. A switch is control the system power for connecting or dis-connecting. The Power Case (B) offer a space to loaded the batteries (B1), (B2), (B3), (B4) and some electric components which may including an integrated circuit (hereafter as IC) which offer the desired light functions may selected by group combination such as chasing, random, all flashing, pair flashing, sequential, fade in and out, time delay or any conventional light effects while making the integrated circuit (IC). The current invention having a very special design to trigger the circuit by a push on/off switch (S) with a preferred integrated circuit (IC) which will offer a desired functions only while the switch is been push on. As long as the switch is been disconnected, the desired function will stop at once. This will not violate any earlier US patents such as US patents under Nick Rogers or Wei etc. All the prior art for the circuit control system is mainly judged by a light function starting when the switch leave the contact-position or when the switch just touch the contact-position, all prior arts the light function will be triggered for pre-determined time period then finish the light effects. The current invention is not use this kind of so called “Vibration switch” because will cause a lot of power consumption during the delivered by truck, boat, air-plane, container etc. The current invention also work with integrated circuit but the function will start while the “push on/off switch been pushed on by weight” and start to work for desired chasing, random, sequential, fade in/out, random, all flashing or any conventional light function at once. While the weight is disappeared, the light will be stop at once. Hence, this is not same as any prior arts.

From FIG. (1), the battery case (B) allow to have multiple batteries which may in desired electric connections of those batteries in series and in-parallel to get desired voltage and amperage to drive the desired different LED or LED(s). This is been disclosure the co-inventor's prior U.S. Pat. No. 5,599,088.

From FIG. (2), Can see more details for the all fiber optics well arranged on the lower surface of Butterfly (D1) and a multiple number of the fiber optics guide the light to the tip to make the contour of the butterfly (D1) been lit. The body of the butterfly (BD1) is made by a plastic material to offer the special light effects with its tube like dimension and clear or opaque plastic particles. All fiber optics form a bundle (F1) and come into a adaptor means (H11) and connected with the adaptor means (H12) to allow the all light beams into the Fiber Optics bundle (F1) to allow the each of fiber optics get the maximum light beams to become very bright. The conductive means (C1) is a wire sets which deliver all the electric signals to the light means (L1) which may be a single piece or polarity of the LED with desired diameter, sealing which may selected from the dice, chip, sealed unit, flat, condenser lens type, convex lens type, super slim, wide view angle type which can be any type which are available from convention market place.

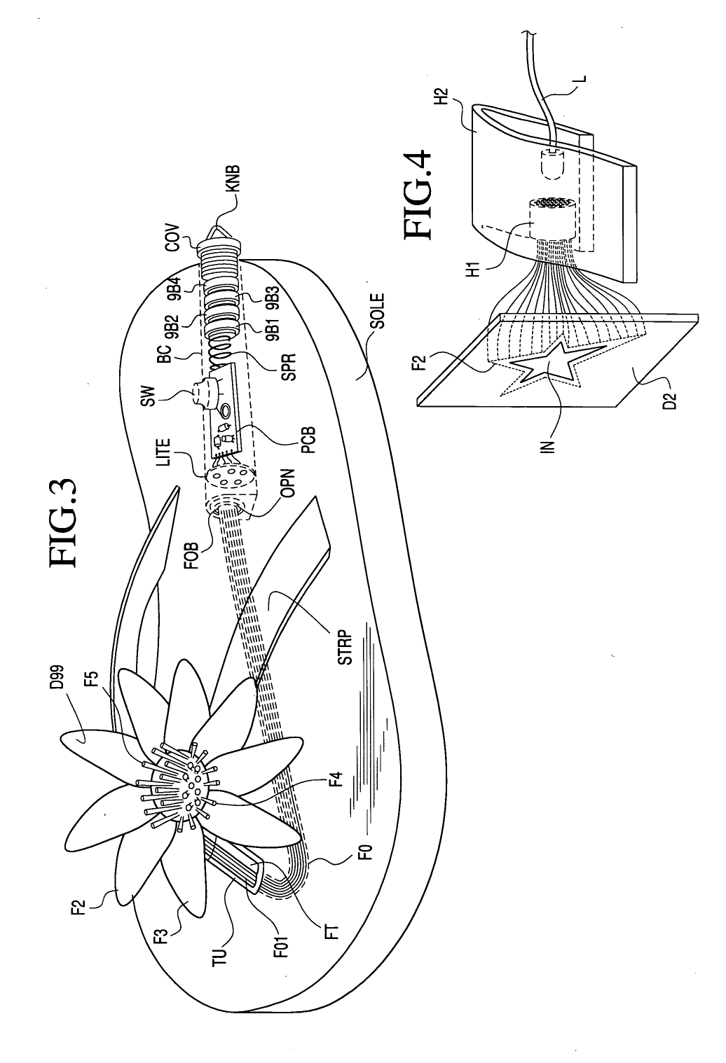

From FIG. 3, Disclosure a super thin basic substrate which is part of the footwear, such as the indoor slipper shoe upper. This is not the limited for the scope of the current invention. It is just one of the embodiments for the current invention for example. From FIG. 3, the basic substrate (D2) is part of the footwear having its indicia, artwork, and designs of the surface. All the fiber optics (F2) surrounds the contour arrangement of the said indicia, artwork, and designs of the surface. Because the basic substrate is very thin thickness and having very narrow space for the optics fiber so all fiber optics are passing though the pre-designed holes. All fiber optics been cut as high as the basic substrate's surface (recessed) or as desired heights to make proper light effects.

The Fiber Optics bundles for this embodiment is small so can use adaptor-means as a simple black tape which is not allow the light emitted out or loosen. The light source(L) have good alignment with the bundle (F2) end so all the light beams will pass into the bundle without any light intensity been wasted. The adaptor means with alignment arrangement is variable basing on the space and design. The fiber optics bundle (F2) can use the simple PVC transparent tape to hold all fiber optics together so can make a quickly work while the space is limited or special requirement needed. Hence, the variable procedure, process, arrangement for the fiber optics on the basic substrate is within the scope of current invention. Same situation for adaptor means, alignment process will be also appreciated for all alternative methods and process, procedure.

From FIG. (4), Disclosure the 4^{th} embodiment which have a plurality of fiber optics fixed on the one of surface and the other surface with colors, paint, design, indicia, art work, and plurality of the basis substrate display units (F1) (F2) (F3) (F4) (F5) with proper cutting, bending, folding, double layers to make shape and become the light kits. The other end of the fiber optics bundle (FOB) is connected with the battery compartment form the opining on one side (OPN) close with the build-in plurality of LED(s) (LITE), Circuit system (PCB), IC, Conductive means (SPR), removable cover (COV) with knob (KNB), press sensitive switch (SW) to allow the people to change the batteries whenever they wanted and the light kits will be turn on and off while the people walked and press the sensitive switch (SW).

The battery compartment also can be non-replaceable battery design, this depend on the market requirement. From FIG. (4), Disclosure the application for the beach sandal and the bundle of fiber optics (FO1) and strap's tongue (FT) are hold together by the very nice and soft tube (TU) for the comfortable wearing. The standard strap's tongue around 5 mm diameter and the best optics bundle diameter also try to make near this 5 mm diameter will be preferred.

Although, the preferred embodiment of the invention have been described in details. It will be appreciated that the scope of the invention is not to be limited to the described embodiments, but rather that the invention is to be interpreted in accordance with the appended claims.

1. A fiber optics light kits for footwear incorporated:
At least one light emitted diode to act as light means to offer strong light beams to the one end of the said fiber optics and delivery to the other end for illumination.
At least one basic substrate to offer a surface to install the said fiber optics well arranged on with desired density of the fiber optics on the said surface by a proper attachment means to attach the said each of the fiber optics on the desired location.
At least one adaptor means with two parts, 1^{st} part of the adaptor to hold all fiber optics bundle(s) for desired shortest length and the 2^{nd} part of adaptor is hold the said light means with proper alignment means to allow light beams been deliver by the fiber optics to the desired end of the fiber optics bundle for illumination.
At least one of the conductive means to delivery the electric signals from the circuit to the light means which is far away from the batteries compartment.
At least one of the push on and off switch to connected with the circuit means to make the circuit can be operated as desired functions incorporated the desired integrated circuit and batteries in desired connection selected by group combination from in-series, in-parallels.
At least one fix means to install the fiber optics in a certain shape, size, and dimension on the footwear.
The improvement:
The batteries can be connected by group combination selected from in-series and in-parallels to allow circuit can drive the different color LED or LED(s).
Further more, the light desired function(s) controlled by IC and the said IC is start to work while the weight is applied to the said push on and off switch and the desired function(s) will be stop while the weight is away from the said push on and off switch. The desired functions may selected from group combination of chasing, sequential, random flashing, all flashing, fade in and out, pair flashing and time counting features to control the power saving function to create marketing conventional light function(s).

2. The fiber optics light kits for footwear as claimed in claim 1, the footwear means may is any kind of the footwear for people to wear.

3. The fiber optics light kits for footwear as claimed in claim 1, the LED or LED(s) means may selected from group of number, shape, illumination, dimension, colors, size, sealing, connection means with conductive means for the desired the said of light means.

4. The fiber optics light kits for footwear as claimed in claim 1, the Integrated Circuit (IC) can have any combination of conventional functions incorporated the push on and off switch to become a trigger means to drive the circuit for light function(s).

5. The fiber optics light kits for footwear as claimed in claim 1, the attached means may selected from the group combination of glue, solvent, chemicals, hot sealing, ultrasonic sealing, double side, tape to attach the fiber optics to the surface of basic substrate.

6. The fiber optics light kits for footwear as claimed in claim 1, the density of fiber optics attached to the basic substrate can be any kind of density.

7. The Fiber optics light kits for footwear as claimed in claim 1, the said light kits may have polarity of basic substrate with preferred fiber optics density.

8. The fiber optics light kits for footwear as claimed in claim 1, the adaptor means may be a tape, glue, double side tape, chemicals to make the fiber optics bundle and light means can be alignment well to deliver the light beams from the light means to the bundle.

9. The fiber optics light kits for footwear as claimed in claim 1, the IC design incorporated with the time counting device and will disconnect the power source with circuit if the people stand on the push on and off switch over a period of time to save the power consumption.

10. The fiber optics light kits for footwear as claimed in claim 1, the IC design incorporating the color mixed features so can use marketing available LED(s) to get the light kits with color changeable features.

11. The fiber optics light kits for footwear as claimed in claim 1, the IC design incorporating the push on and off switch with time counting device while the wear continuously pressed the said switch over a period of time, the IC will disconnect the power source with the circuit or any equivalent function to save the power consumption.

12. The fiber optics light kits for footwear as in claim 1, the LED or LED(s) away from the batteries case but as close as the fiber optics shortest bundle end.

13. The fiber optics light kits for footwear as claimed in claim 1, the Substrate can be cut some portion and fold into some geometric shape such as flower, butterfly, leaves for making some 3 dimensional item.

14. The fiber optics light kits for footwear as claimed in claim 1, the substrate can be just a part or component of the said of footwear and each of fiber optics just passing though the hole to make a contour of the footwear's logo, indicia, trademark, cartoon, and designs which the contour illumination caused by one end of the fiber optics.

15. The fiber optics light kits for footwear as claimed in claim 1, the substrate can be directly apply to the footwear for shoe upper surface, outsole, side wall, shoe tongue, lace by stitching, glue, enveloping, pocketing, underlay process.

16. The fiber optics light kits for footwear as claimed in claim 1, the substrate can add indicia, logo, trade-mark, art work by painting, silkscreen, die, or conventional printing procedure to make the substrate with colorful appearance.

17. A footwear with fiber optics light kits consist of:
At least one end of the fiber optics bundle connect with a battery replaceable compartment with proper sealing on two ends of said compartment, one of the end can be removable to make batteries replacement.
The other side of the said bundle of fiber optics has plurality of thin fiber optics fixed on one surface of the basic substrate to form a display unit, and the other side of the surface with designs, shape, indicia, colors, painting, decorative stuffs to form an eye-catching appearance. The polarity of the display units with proper cutting, bending, folding, combination, glue, orientation, organization to make a pretty object as light kits.
The battery compartment with build in plurality of LEDs to offer the desired colors, functions, brightness though the IC and circuit means with press sensitive switch and conductive means to deliver the batteries power to drive the said circuit system to make the said LEDs for desired illumination and functions.
The said battery compartment contained one end of the said fiber optics bundle, plurality of LEDs, IC, Circuit system, conductive means, batteries, removable cover for battery replacement, and press sensitive switch.
The improvement including:
The footwear has a battery replacement compartment suit on the proper location for people to change batteries and has the said light kits on shoe surface, outsole, or the shoe bottom for desired functions.

18. A footwear with fiber optics light kits consist of:
At least one end of the fiber optics bundle connected with a battery compartment with proper sealing on two ends of said compartment.
The other side of the said bundle of fiber optics has plurality of thin fiber optics fixed on one surface of the basic substrate to form a display unit, and the other side of the surface with designs, shape, indicia, colors, painting, decorative stuffs to form colorful unit. The polarity of the display units with proper cutting, bending, folding, combination, glue, orientation, organization to make a pretty object as light kits.
The battery compartment with build in LED(s) to offer the desired colors, functions, brightness though the IC and circuit means with press sensitive switch and conductive means to deliver the batteries power to drive the said circuit system to make the said LED(s) for desired illumination and functions.
The said battery compartment contained one end of the said fiber optics bundle, of LED(s), IC, Circuit system, conductive means, batteries, and press sensitive switch
The improvement including:
The footwear has battery compartment suit on the proper location and display unit on shoe surface, outsole, or the shoe bottom for desired functions.
